(19) United States
(12) Patent Application Publication
(10) Pub. No.: US 2021/0370491 A1
(43) Pub. Date: Dec. 2, 2021

(54) FLOATING HAND TOOL

(71) Applicant: Chris Urbanek, Algonac, MI (US)

(72) Inventor: Chris Urbanek, Algonac, MI (US)

(21) Appl. No.: 17/404,448

(22) Filed: Aug. 17, 2021

Related U.S. Application Data
(63) Continuation-in-part of application No. 15/431,702, filed on Feb. 13, 2017, now abandoned.
(60) Provisional application No. 62/095,040, filed on Dec. 21, 2014.

(51) Int. Cl. B25G 1/10; B25G 1/00

(52) U.S. Cl. CPC B25G 1/105; B25G 1/005

(57) ABSTRACT

The floating hand tool is configured to float in a body of water. The floating hand tool includes a handle made of a floatable material. The floating handle replaces the grip on ratchets, screw drivers, and any hand tool used in water with floatable grips. The handle includes a handle portion and a cap. The handle portion includes a protrusion. The cap includes a recess. The protrusion is configured to selectively interact with the recess, thereby coupling and sealing the handle portion to the cap.

### CROSS REFERENCE TO RELATED APPLICATIONS

This application is a continuation-in-part of U.S. patent application Ser. No. 15/431,702, filed Feb. 13, 2017, which in turn claims the benefit of U.S. Provisional Application No. 62/095,040, filed on Dec. 21, 2014, the entire disclosures of which are incorporated herein by reference.

### FIELD

The present disclosure generally relates to a hand tool and, more particularly, to a floating hand tool.

### INTRODUCTION

This section provides background information related to the present disclosure which is not necessarily prior art.

The present technology relates generally to the field of hand-tool devices and more specifically relates to a floating hand tool that floats in water. The tool provides a handle manufactured from a material which floats in water. The floatable handle replaces the grip on ratchets, screw drivers, and any hand tool which may be used in the water with floatable grips.

A hand tool is any tool that is not a power tool that is, one powered by hand rather than by a motor or engine. Some examples of hand tools are garden forks, secateurs, rakes, hammers, spanners, pliers, screwdrivers, and chisels. Hand tools are generally less dangerous than power tools.

A search of the prior art reveals various hand tools and associated devices which have been developed to provide means to solve problems found in floatable hand-tool devices art. None are closely related to the present technology, but several include features which resemble those of the present technology. Each has proven to be less than satisfactory in its own way.

Method and apparatus for enabling hand tools to float, U.S. Pat. No. 6,726,516 (priority Dec. 27, 2001), provides a grip comprising a tubular sleeve which is placed over a handle or pre-existing tool grip and enables the tool to float grip side up, thereby allowing the tool to be easily seen and retrieved. The grip may have varying thicknesses and diameters and may be colored or treated with a luminescent or reflective coating so as to be easily seen. The grip material may also be selected so that it molds to the user's hand during use.

Buoyant hand tool, U.S. Pat. No. 6,877,405 (priority Jan. 3, 2003), provides a non-conductive, substantially buoyant-in-water hand tool comprising an elongated handle portion formed of non-corrosive, non-conductive material having a density greater than water and an elongated working tool connected to and extending axially from a proximal end of said handle portion. The handle portion has one or more outwardly opening cavities formed into a side surface of the handle portion. An elongated tubular sheath formed of material buoyant in water covers and seals, encloses, and forms one or more airtight cavities whereby the effective density of the hand tool is less than that of water.

Floatable hand tool, U.S. Pat. No. 7,272,997 (filed Apr. 24, 2006), provides a shank having an inner wall formed with an axially extending through hole, and a tool tip mounted on an end of the shank and having an end portion provided with a protruding connecting rod inserted into the through hole of the shank so that the through hole of the shank forms a closed chamber. Thus, the floatable hand tool floats on the water level by the floating force produced by the closed chamber formed by the through hole of the shank. In addition, the floatable hand tool floats on the water level, thereby preventing the floatable hand tool from being missed when falling into the water, and thereby facilitating a user operating the floatable hand tool in the water.

Floating, non-conductive hand tools, U.S. Pat. No. 5,865,077 (filed Sep. 27, 1996), provides floating, nonconductive hand tool such as pliers or channel locks for use by those working proximate to water or an electrical source. The tools are extremely durable, lightweight, and have an internal cavity capable of holding a gas or a light weight polymer foam material to substantially reduce the overall density of the hand tool. Alternatively, the handle ends of the tool may be encased with a low density sheathing material, used either independently or in conjunction with the aforementioned internal cavity to reduce the density of the tool.

Some of the prior art inventions present certain disadvantages. The present technology has been developed for the purpose of addressing and resolving these disadvantages. A floating hand tool that floats in water, which provides a handle manufactured from a material which floats in water, would resolve these problems.

There is a continuing need for a floating hand tool that provides a more secure seal. Desirably, a user may engage the floating hand tool in tight environments.

### SUMMARY

In concordance with the instant disclosure, a floating hand tool that provides a more secure seal, and which may be engaged in tight environments, has been surprisingly discovered.

Accordingly, the present technology is directed to a floating hand tool. The general purpose of the present technology, which will be described subsequently in greater detail, is to provide a hand tool that floats in water. The tool contains a handle made of a floatable material. The floatable handle replaces the grip on ratchets, screw drivers, and any hand tool used in water with floatable grips.

The floating hand tool can include various aspects, including a floatable handle that replaces the conventional handgrip on a hand-tool. The floatable handle may be coupled to the hand-tool via an epoxy resin. Various types of hand-tools may be used with the floatable handle, including various types of ratchets, screwdrivers, and wrenches used in an aquatic environment. The handgrip of the floatable handle may conform to a hand of a user to increase comfort when the hand-tool is in use. The floatable handle may be made of high-impact plastic, aluminum alloy, polystyrene, fiberglass, balsa wood, aerogel with helium, polyethylene composite, and the like. Where the floatable handle may be made of high-impact plastic, aluminum alloy, polystyrene, fiberglass, balsa wood, aerogel with helium, polyethylene composite, and the like, and any combinations thereof, the weight of the hand-tool plus the floatable handle may have a reserve buoyancy such that the weight of the hand-tool is greater than a weight of water that it displaces.

The features of the present technology which are believed to be novel are particularly pointed out and distinctly claimed in the concluding portion of the specification. These and other features, aspects, and advantages of the present technology will become better understood with reference to the following drawings and detailed description.

Additional features and advantages of the present technology will be set forth in the description which follows, and will be apparent from the description, or may be learned by practice of the present technology. The foregoing general description and the following detailed description are exemplary and explanatory and are intended to provide further explanation of the present technology and are not intended to limit the scope of the present disclosure.

### DRAWINGS

The accompanying drawings are included to provide a further understanding of the invention and are incorporated into and constitute a part of the specification. They illustrate certain embodiments of the present technology and, together with the description, serve to explain the principles of the invention.

FIG. 1 is a side cutaway view of the first exemplary embodiment, displaying the handle, the interior space, and the endcap.

FIG. 2 is a side cutaway view of the first exemplary embodiment with the endcap removed, displaying the handle, the interior space/chamber, and the endcap.

FIG. 3 is a top perspective view of the floating handle, according to one embodiment of the present disclosure;

FIG. 4 is a top plan view of the floating handle, as shown in FIG. 3;

FIG. 5 is a top perspective view of the floating handle, depicting the handle portion having a shorter length than the handle portion as shown in FIGS. 3-4, according to one embodiment of the present disclosure;

FIG. 6 is a top plan view of the floating handle, as shown in FIG. 5;

FIG. 7 is a top plan, exploded view of the floating handle, as shown in FIGS. 3-4, according to one embodiment of the present disclosure;

FIG. 8 is a cross-sectional view of the floating handle, taken at section line A-A in FIG. 4, according to one embodiment of the present disclosure;

FIG. 9 is a front elevational view of the floating handle, as shown in FIGS. 3-4, depicting the tool with a phantom line, according to one embodiment of the present disclosure; and

FIG. 10 is a flowchart of a method for constructing the floating handle, according to another embodiment of the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping, or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the FIGS. is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

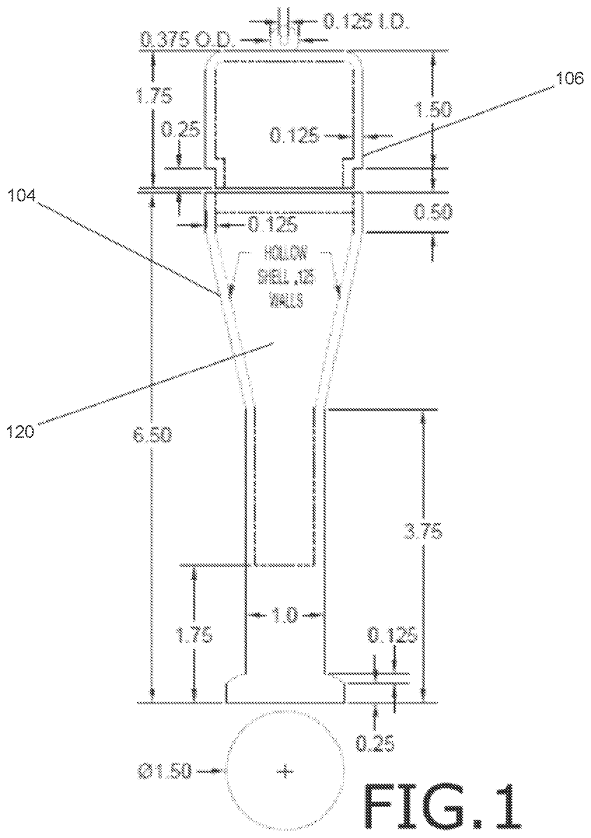

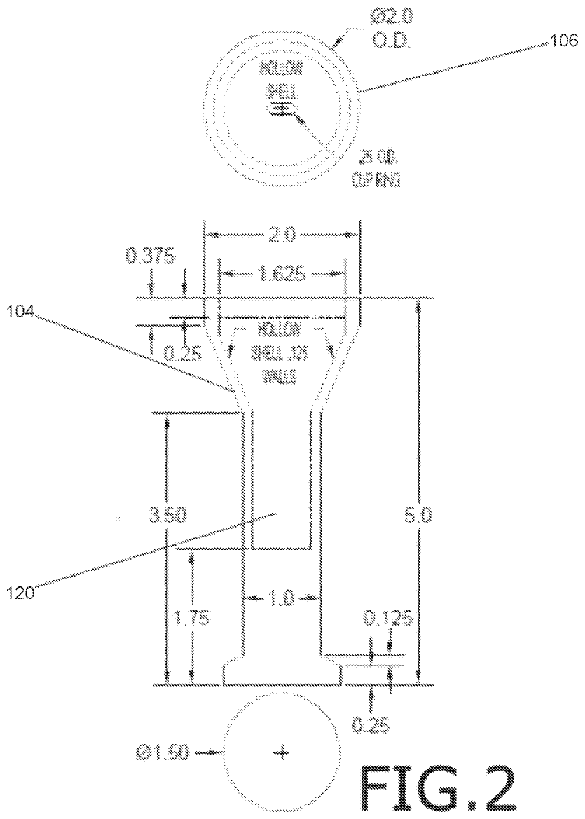

In certain embodiments, as shown in FIGS. 1-8, the floating handle 100 may be configured to be coupled to a tool 102. The floating handle 100 includes a handle portion 104 and an endcap 106. The handle portion 104 may have a first end 108 and a second end 110. The first end 108 of the handle portion 104 may be configured to be coupled to the tool 102. The endcap 106 may have a first end 112 and a second end 114. The first end 112 of the endcap 106 may be configured to be selectively coupled to the second end 110 of the handle portion 104. The first end 112 of the endcap 106 may include a protrusion 116. The second end 110 of the handle portion 104 may include a recess 118 configured to selectively engage the protrusion 116 where the endcap 106 is coupled to the handle portion 104.

In certain embodiments, the tool 102 may include a hand tool, such as a screwdriver or crescent wrench which is similar in structure and function to a conventional hand tool of the same type, with the following modifications. The handle portion 104 may be hollow and roughly cylindrical and/or conically shaped, providing a sufficient volume for a large interior space and/or chamber 120 for flotation purposes. The first end 108 of the handle portion 104 may taper slightly and may be affixed to the shaft of the hand tool 102 with epoxy or a similar adhesive. The second end 110 of the handle portion 104 may be removably coupled to the first end 112 of the endcap 106. In a specific example, the second end 110 of the handle portion 104 may include threads (not shown) which are configured to interact with complementary threads (not shown) on the first end 112 of the endcap 106, thereby creating a watertight seal when affixed to the endcap 106.

In certain embodiments, the floating handle 100 may be configured to replace a preexisting grip on the hand tool 102, which may include ratchet wrenches, crescent wrenches, and screwdrivers which are used in water. The surface of the handle portion 104 may conform to a hand of a user, thereby increasing comfort when in use.

A primary benefit of the present invention is if the tool 102 is dropped in water, the floating handle 100 may cause the tool 102 to float, thereby leading to a fast recovery of the hand tool 102. The present technology is ideal for boat owners or for anyone who works around water. In certain embodiments, the user may grasp the floating handle 100 and use the tool 102 in the same manner as a conventional tool.

The floating handle 100 may be manufactured from rigid, durable materials which are relatively low density, such as high-impact plastic or aluminum alloy. In a specific example, the floating handle 100 may be constructed with polypropylene. In a more specific example, the floating handle 100 may be constructed with 6323 grade polypropylene. In another specific example, the handle portion 104 and endcap 106 may include a sidewall 123 having a thickness T of about one eighth of an inch thick. Advantageously, the thin sidewall 123 and lightweight material of the floating handle 100 may decrease the overall weight of the floating handle 100. Components, component sizes, and materials listed above are preferable, but artisans will recognize that alternate components and materials could be selected without altering the scope of the present technology.

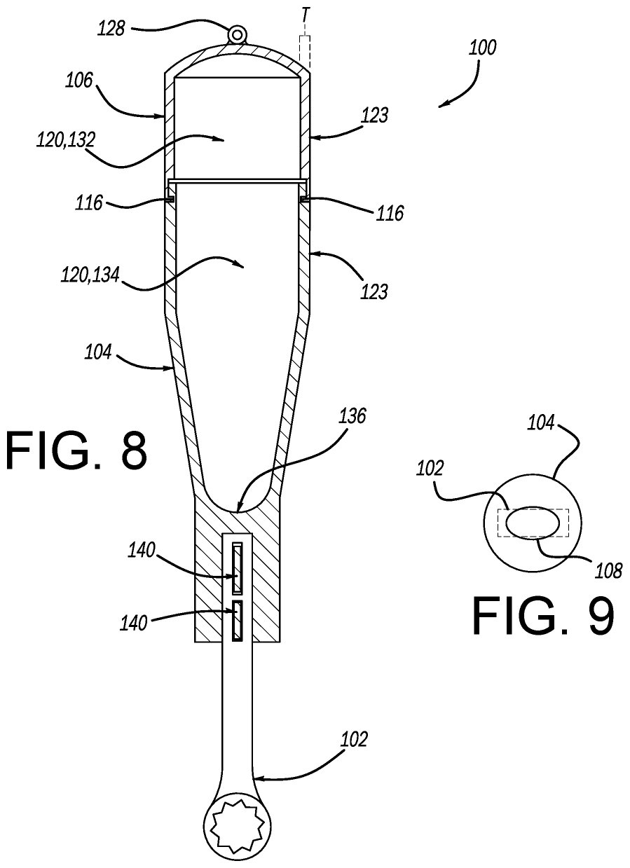

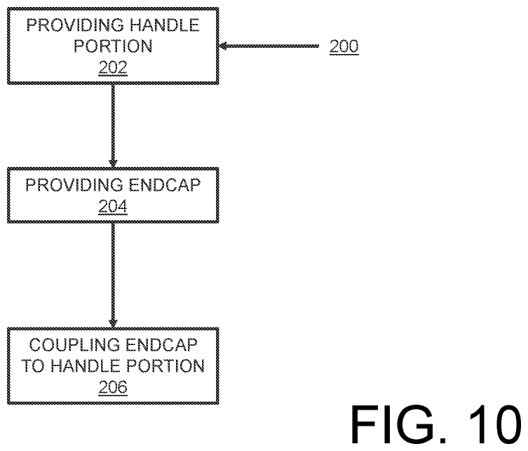

In certain embodiments, as shown in FIGS. 7-8, the floating handle 100 may include ways of coupling the handle portion 104 to the endcap 106. The protrusion 116 may be configured to be selectively accepted by the recess 118. In certain circumstances, the protrusion 116 may be disposed on an annular projection 122 on the first end 112 of the endcap 106. The recess 118 may be disposed on a lip 124 on the second end 110 of the handle portion 104. In a specific example, the annular projection 122 may be configured to selectively accept the lip 124 thereby coupling the endcap 106 to the handle portion 104 via a friction fit design.

In certain embodiments, the protrusion 116 at the first end 112 of the endcap 106 may be disposed on an inner surface 126 of the annular projection 122. The recess 118 of the second end 110 of the handle portion 104 may be disposed in the lip 124. In a specific example, the protrusion 116 may be an annular protrusion 116 disposed on the inner surface 126 of the annular projection 122. With continued reference to the specific example, the recess 118 may be an annular recess 118 disposed around the lip 124. The annular protrusion 116 may be configured to be disposed within the annular recess 118, thereby more securely coupling the endcap 106 to the handle portion 104. Advantageously, the annular protrusion 116 and annular recess 118 features may enhance the airtight seal between the endcap 106 and the handle portion 104.

In certain embodiments, the endcap 106 may also be coupled to the handle portion 104 using an adhesive (not shown). The adhesive (not shown) may be used in conjunction with the annular protrusion 116 and annular recess 118 features to further enhance the airtight seal. As a non-limiting example, the adhesive (not shown) may be an epoxy. One skilled in the art may select other suitable methods for coupling the endcap 106 and the handle portion 104, within the scope of the present disclosure.

In certain embodiments, the floating handle 100 may include a way of coupling a lanyard, rope, clip, or snap thereto. In a specific example, the floating handle 100 may include a lanyard ring 128 disposed on the second end 114 of the endcap 106. The lanyard ring 128 may be sized and shaped in manner configured to accept a string, rope, cord, and or clip. Advantageously, the lanyard ring 128 may permit a user to couple the floating handle 100 to an anchoring structure (not shown), thereby militating against the floating handle 100 from undesirably floating away.

In certain circumstances, the floating handle 100 may include ways of enhancing its visibility when disposed in a body of water. For instance, the endcap 106 may have a different color than the handle portion 104, thereby creating a bobber-like color contrast and enhancing its visibility. Examples of high-visibility colors include chartreuse and dayglo orange.

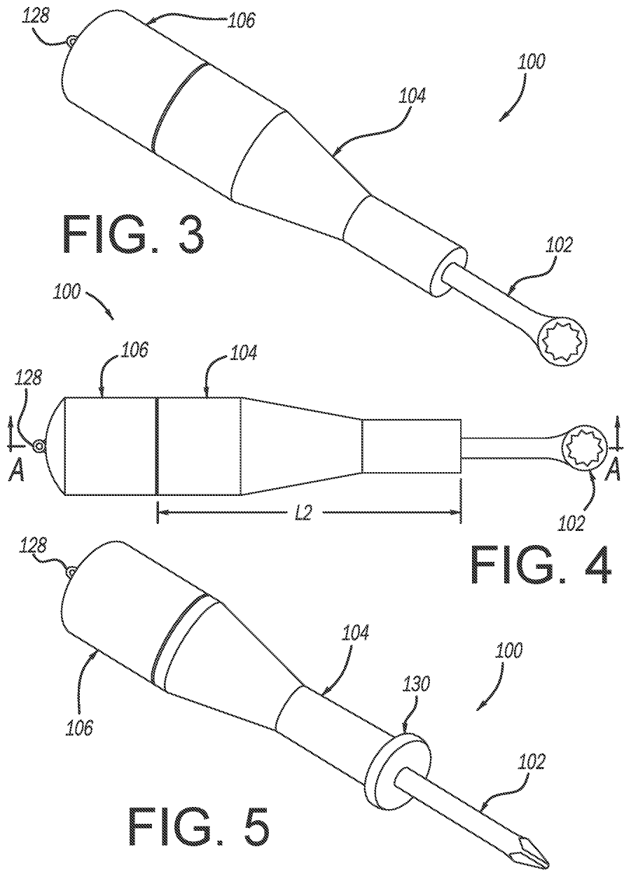

In certain circumstances, the floating handle 100 may include ways of permitting the floating handle 100 to be engaged in small spaces. For instance, as shown in FIGS. 3 and 9, the first end 108 of the handle portion 104 may include a cross-section that is substantially oval-shaped. The tool 102 in FIG. 9 has been shown with phantom lines to clearly show the oval-shaped first end 108 of the handle portion 104. Where the first end 108 of the handle portion 104 is oval-shaped, the first end 108 of the handle portion 104 may allow the tool 102 along with the first end 108 of the handle portion 104 to fit into tighter workspaces and be accepted in smaller locations while still providing adequate strength to support the tool 102. Advantageously, the oval-shaped cross section may allow the first end 108 of the handle portion 104 to fit into tighter environments, such as near a boat engine.

In certain circumstances, the floating handle 100 may include a guard 130 on the first end 108 of the handle portion 104. The guard 130 may circumscribe around the first end 108 of the handle portion 104. Advantageously, the guard 130 may militate against a hand of the user from undesirably sliding along the handle portion 104.

In certain circumstances, the endcap 106 may include a first cavity 132 and the handle portion 104 may include a second cavity 134. When the endcap 106 is coupled to the handle portion 104, the first cavity 132 and second cavity 134 may form a single airtight chamber 120. The single airtight chamber 120 may be substantially conically shaped relative to a longitudinal axis of the floating handle 100. In a specific example, the second cavity 134 may have a rounded end 136 nearest the first end 108 of the handle portion 104. Without being bound to any particular theory, it is believed the shape of the rounded end 136 enhances the structural integrity of the handle portion 104. Likewise, a larger diameter of the single airtight chamber 120 opposite the rounded end 136 may enable the endcap 106 to float high in the water when dropped therein, thereby increasing the visibility of tool 102 when floating.

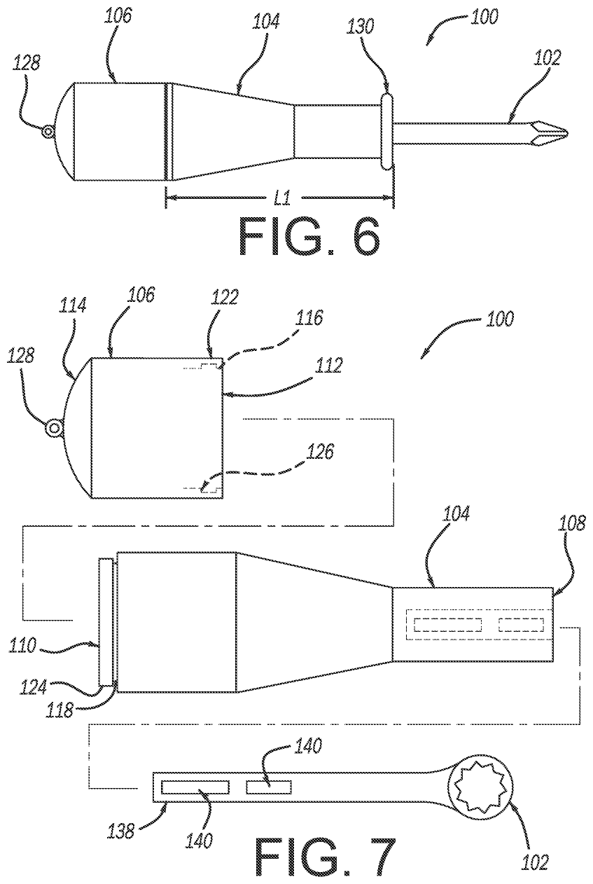

In certain circumstances, the handle portion 104 may include ways of modifying a volumetric capacity of the single airtight chamber 120 to provide enhanced floatation to tools 102 of various sizes. For instance, the handle portion 104 may be provided in various lengths. In a specific example, as shown in FIG. 6, the handle portion 104 may have a first length L1 of about five inches to provide adequate floatation to lighter hand tools 102, such as a screwdriver. The handle portion 104 may also be provided with a second length L2 of about six and a half inches, as shown in FIG. 3, to provide a greater volumetric capacity of the single airtight chamber 120, thereby providing adequate floatation to heavier hand tools 102, such as a wrench.

In certain circumstances, the floating handle 100 may be configured to be more securely coupled to a tang 138 of a tool 102. For instance, the tang 138 of the tool 102 may have milled through holes 140. The milled through holes 140 may be filled by the handle portion 104. For instance, the floating handle 100 may be molded around the tang 138 of the tool 102, thereby allowing the material used to mold the floating handle 100 to flow through the milled through holes 140. Without being bound to any particular theory, it is believed the structural integrity of the floating handle 100 is enhanced and better supported where the milled through holes 140 of the tool 102 are filled by the handle portion 104.

In a further embodiment, as shown in FIG. 9, the floating handle 100 may include a method 200 for constructing the floating handle 100 configured to be coupled to a tool 102. The method 200 may include a step 202 of providing a handle portion 104 having a first end 108 and a second end 110. The first end 108 of the handle portion 104 may be configured to be coupled to the tool 102. The method 200 may also include a step 204 of providing an endcap 106 having a first end 112 and a second end 114. The first end 112 of the endcap 106 may be configured to be selectively coupled to the second end 110 of the handle portion 104. The first end 112 of the endcap 106 may include a protrusion 116. The second end 110 of the handle portion 104 may include a recess 118 configured to selectively engage the protrusion 116 when the endcap 106 is coupled to the handle portion 104. The method 200 may further include a step 206 of coupling the endcap 106 to the handle portion 104.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

What is claimed is:

1. A floating handle configured to be coupled to a tool, the floating handle comprising:
a handle portion having a first end and a second end, the first end of the handle portion configured to be coupled to the tool; and
an endcap having a first end and a second end, the first end of the endcap configured to be selectively coupled to the second end of the handle portion, the first end of the cap including a protrusion, the second end of the handle portion including a recess configured to selectively engage the protrusion, thereby coupling the endcap to the handle portion.

2. The floating handle of claim 1, further comprising an annular projection extending from the first end of the endcap.

3. The floating handle of claim 2, further comprising a lip disposed around the second end of the handle portion, the lip configured to be selectively accepted by the annular projection.

4. The floating handle of claim 3, wherein the protrusion is disposed on an inner surface of the annular projection.

5. The floating handle of claim 4, wherein the recess is disposed in the lip.

6. The floating handle of claim 4, wherein the protrusion is an annular protrusion disposed on an inner surface of the annular projection.

7. The floating handle of claim 5, wherein the recess is an annular recess disposed around the lip.

8. The floating handle of claim 1, further comprising a lanyard ring disposed on the second end of the endcap.

9. The floating handle of claim 1, wherein the endcap is a different color than the handle portion.

10. The floating handle of claim 1, wherein the first end of the handle portion has a cross-section that is oval-shaped.

11. The floating handle of claim 1, further comprising a guard on the first end of the handle portion.

12. The floating handle of claim 11, wherein the guard circumscribes the first end of the handle portion.

13. The floating handle of claim 1, wherein a sidewall of the handle portion is about one eighth of an inch thick.

14. The floating handle of claim 1, wherein the endcap includes a first cavity, the handle portion includes a second cavity, the endcap is coupled to the handle portion, and the first cavity and second cavity form a single airtight chamber.

15. The floating handle of claim 14, wherein the single airtight chamber is substantially conically shaped.

16. The floating handle of claim 1, wherein the second cavity has a rounded end nearest the first end of the handle portion.

17. The floating handle of claim 1, wherein the handle portion has a length of about five inches.

18. The floating handle of claim 1, wherein the handle portion has a length of about six and a half inches.

19. A floating hand tool comprising:
a tool including a tang, the tang having an aperture therethrough; and
a floating handle including:
a handle portion a first end and a second end, the first end of the handle portion coupled to the tool, the aperture of the tang including material of the handle portion; and
an endcap having a first end and a second end, the first end of the endcap configured to be selectively coupled to the second end of the handle portion, the first end of the cap including a protrusion, the second end of the handle portion including a recess configured to selectively engage the protrusion, thereby coupling the endcap to the handle portion.

20. A method for constructing a floating handle configured to be coupled to a tool, the method comprising the steps of:
providing a handle portion having a first end and a second end, the first end of the handle portion configured to be coupled to the tool;
providing an endcap having a first end and a second end, the first end of the endcap configured to be selectively coupled to the second end of the handle portion, the first end of the cap including a protrusion, the second end of the handle portion including a recess configured to selectively engage the protrusion to couple the endcap to the handle portion; and
coupling the endcap to the handle portion.
